(19) United States
(12) Patent Application Publication
(10) Pub. No.: US 2025/0009041 A1
(43) Pub. Date: Jan. 9, 2025

(54) USER INTERFACE FOR AEROSOL-GENERATING DEVICE AND SYSTEM

(71) Applicant: NICOVENTURES TRADING LIMITED, London (GB)

(72) Inventor: Dominic WOODCOCK, London (GB)

(21) Appl. No.: 18/713,311

(22) PCT Filed: Nov. 8, 2022
(86) PCT No.: PCT/GB2022/052821

§ 371 Date: May 24, 2024

(30) Foreign Application Priority Data
Nov. 26, 2021 (GB) 2117071.7

(51) Int. Cl. A24F 40/60; A24F 40/51; A24F 40/65; G06F 3/0482; G06F 3/0484; G06F 3/0488

(52) U.S. Cl. CPC A24F 40/60; A24F 40/51; A24F 40/65; G06F 3/0482; G06F 3/0484; G06F 3/0488

(57) ABSTRACT

A non-combustible aerosol-generating device is disclosed. It comprises a display for displaying an image visible to a user in an activated state, and control circuitry configured so that a default image is always displayed on the display when the display is in an activated state. The control circuitry is also configured to enable at least one user-selectable image of a plurality of user-selectable images to be displayed in addition to the default image. A non-combustible aerosol-generating system comprising the non-combustible aerosol-generating device according to the invention is also disclosed, together with a method of controlling the non-combustible aerosol-generating device.

### TECHNICAL FIELD

The present specification relates to a non-combustible aerosol-generating device, to a non-combustible aerosol-generating system, and to a method of controlling a non-combustible aerosol-generating device.

### BACKGROUND

Smoking articles, such as cigarettes, cigars and the like burn tobacco during use to create tobacco smoke. Attempts have been made to provide alternative delivery devices to these articles by creating products that release compounds without combustion. Examples of such delivery devices are so-called “heat not burn” products or tobacco heating devices or products, which release compounds by heating, but not burning, a substrate. For example, tobacco heating devices heat an aerosol generating substrate, which may be tobacco or other non-tobacco products which may or may not contain nicotine, to form an aerosol by heating the substrate without burning it.

### SUMMARY

In accordance with some embodiments described herein, there is provided a non-combustible aerosol-generating device, comprising a display for displaying an image visible to a user in an activated state, and control circuitry configured so that a default image is always displayed on the display when the display is in an activated state; wherein the control circuitry is also configured to enable at least one user-selectable image of a plurality of user-selectable images to be displayed in addition to the default image.

The control circuitry can be configured such that the or each user-selectable image is selectable from a menu of user-selectable images.

The control circuitry can comprise a display driver configured to display the default image, and the at least one user-selected image of the user-selectable images, when the display is in an activated state.

The control circuitry may comprise a communication interface which can supply a signal to the display driver to display at least one user-selected image. In some embodiments, the communication interface can supply a signal to the display driver to swap at least one user-selected image for at least one other user-selectable image selected from said menu. Alternatively, the communication interface can supply a signal to the display driver to deselect at least one user-selected image. The deselected image or images are therefore no longer displayed.

The communication interface may be configured to receive a signal indicative of the at least one user-selected image from a remote device. The remote device can have a user input configured to enable a user to select user-selectable images to be displayed from said menu of user-selectable images on said remote device.

The communication interface may receive a wireless signal from said remote device, such as a Bluetooth signal. The remote device can be a smart phone, a tablet, or a smart watch.

The device may include a memory for storing image data relating to at least one user-selectable image. Furthermore, image data relating to user-selectable images can be downloadable from a remote device and stored in the memory.

In certain embodiments, the communication interface may a touchscreen. In this case, the touchscreen can be configured to enable a user to select images for display as user-selected images from the menu of user-selectable images, in response to a user touching regions of the touchscreen.

The control circuitry may be configured to enable a user to control the device to enter a user-selection mode. A menu of user-selectable images can be is displayed as a list on the display in the user-selection mode. The control circuitry may allow a user to select images for display as user selected images by touching items in said list, or by dragging selected items from the menu to another region of the screen spaced from said menu.

The touchscreen can be a resistive or capacitive touchscreen.

In some embodiments, one or more of the default images are touch-sensitive icons. The control circuitry can then be configured such that an aspect of the aerosol-generating device is controlled in response to touching one or more of the default images. For example, a default image may be an on/off switch, and the device may be turned on and off by touching the default image.

In addition, or alternatively, one or more of the user-selectable images, when selected as user selected images, can be touch-sensitive icons. In this case, the control circuitry may be configured such that an aspect of the aerosol-generating device is controlled in response to touching one or more of the selected user-selectable images.

In any of the embodiments of the invention, the control circuitry can also be configured to detect the presence of a user and/or a remote device in the proximity of the aerosol-generating device, and to switch the display from a deactivated state in which no image is displayed to an activated state in response to said detection such that said default image, and at least one user-selected image of the menu of user-selectable images, are displayed.

The control circuitry may be configured to control the display so that it switches from an activated to a deactivated state after the control circuitry fails to detect the presence of a user and/or a remote device in the proximity of the aerosol-generating device after a predetermined period of time.

The control circuitry may comprise a sensor 16 to detect the presence of a user and/or a remote device proximal to the aerosol-generating device. The display driver may then be configured to receive a signal from the sensor 16 indicative of said detected presence, and to control the display to switch from a deactivated to an activated state.

The sensor 16 can be configured to detect the presence of a user and/or a remote device when the user and/or the remote device is spaced from the device. The display driver may then switch the display to an activated state without the aerosol-generating device being touched.

The communication interface can be configured to receive an activation signal from said remote device spaced from, but proximal to, the aerosol-generating device, to switch the display of the aerosol-generating device from an inactivated to an activated state.

In another embodiment, the control circuitry can be configured to detect the presence of a user and/or a device spaced from, but proximal to, the aerosol-generating device, and to change or modify a displayed image in response to said detection.

The control circuitry may be configured to detect the presence of a user and/or a remote device spaced from, but proximal to, the aerosol-generating device. In this case, the display driver may be configured to receive a signal indicative of said detected presence, and to change or modify one or more of said displayed user-selected images in response to said detection.

The communication interface may be configured to receive a signal from the remote device spaced from, but proximal to, the aerosol-generating device.

The device can include a housing having an outer surface, and the display may be attached to the outer surface of the housing.

The outer surface of the housing may comprise a contoured shape. The display may then be configured so that it conforms to the contoured shape of the outer surface of the housing.

The housing can be tubular and the outer surface may extend about a longitudinal axis, the display extending about the longitudinal axis for at least 90 degrees, at least 180 degrees or 360 degrees. The display may also extend in a longitudinal direction for substantially the entire length of the housing.

The display may be configured to display an image comprising at least one of a solid colour, a pattern, an animation or a graphic, which can be a static image and/or a moving image. The display can be an OLED, flexy TFT, display, OLCD, e-ink (or EPD), AMOLED or PMOLED display.

According to another aspect, there is provided a non-combustible aerosol-generating system comprising a non-combustible aerosol-generating device according to the invention, and a non-combustible aerosol-generating article receivable in the non-combustible aerosol-generating device.

According to another aspect of the invention, there is provided a method of controlling a non-combustible aerosol-generating device, comprising a display for displaying an image visible to a user in an activated state, the method of control including configuring the display such that a default image is always displayed when the display is in an activated state, and configuring the control circuitry to enable at least one user-selected image to be displayed in addition to the default image, and in which the or each user-selected image is selectable from a menu of user-selectable images.

### BRIEF DESCRIPTION OF THE DRAWINGS

Embodiments of the invention will now be described, by way of example only, with reference to the accompanying drawings, in which:

FIG. 1 is a perspective view of an example of a non-combustible aerosol-generating device for heating smokable material according to an embodiment of the present invention;

FIG. 2 shows a longitudinal cross-sectional view of the device shown in FIG. 1;

FIG. 3 shows an embodiment of a non-combustible aerosol-generating device, in accordance with an embodiment of the invention, in communication with a remote device; and

FIG. 4 illustrates the steps involved in a method of controlling a non-combustible aerosol-generating device according to an embodiment of the invention.

### DETAILED DESCRIPTION

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the non-combustible aerosol provision system is an electronic cigarette, also known as a vaping system or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable, such as an article, for use with the non-combustible aerosol provision device. An aerosol-generating material is a material that is capable of generating aerosol, for example when heated, irradiated or energized in any other way. An aerosol-generating material may be in the form of a solid, liquid or gel which may or may not contain an active substance and/or flavourants.

In some embodiments, the non-combustible aerosol provision device may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

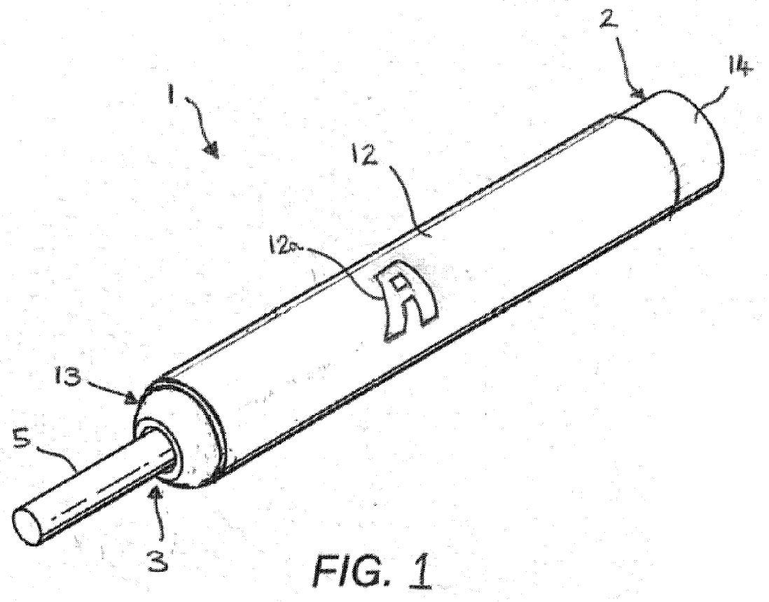

Referring to FIG. 1, there is shown a perspective view of an example of a non-combustible aerosol-generating system, comprising a device 1 and an article 5 received in the device 1. The device 1 is arranged to heat smokable material of the article 5 to volatise at least one component of the smokable material for inhalation by a user. The non-combustible aerosol-generating device 1 is a so-called “heat-not-burn” device 1. The device 1 in this example has a generally elongate cylindrical outer housing 2 of circular cross-section. The outer housing 2 has an open end 3, also referred to as the mouth end. The outer housing 2 may be formed of a heat insulating material. A particularly suitable material is polyether ether ketone (PEEK), though other plastics, including for example acrylonitrile butadiene styrene (ABS), or other heat insulating materials, may be used. The outermost surface of the outer housing 2 may have a decorative coating, such as a metallic finish.

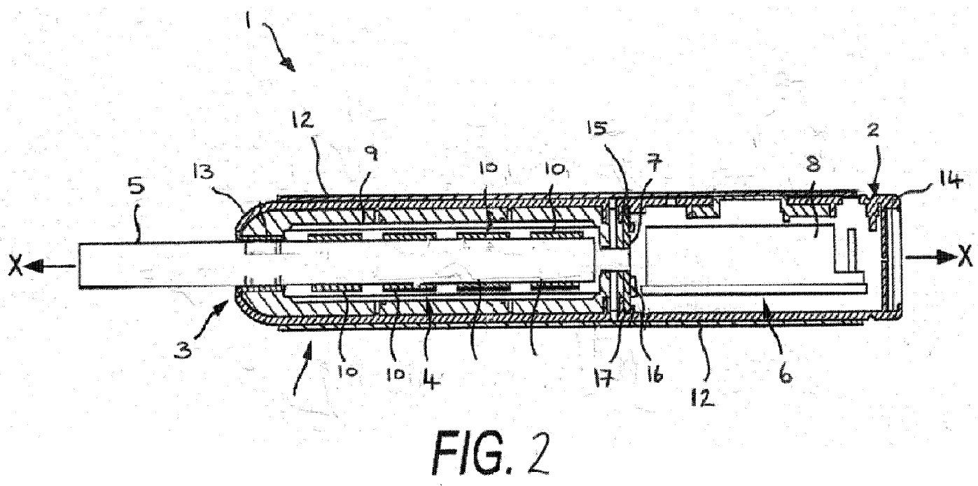

FIG. 2 shows a longitudinal cross-sectional view of the device 1 for heating a smokable material 5, shown in FIG. 1. The system can therefore be considered to be formed of two main components; a device part or aerosol-generating device 1, and a consumable part or aerosol-generating article, generally denoted by smokable material 5. The device part 1 and consumable part 5 are engageable with one another (as shown in FIGS. 1 and 2) such that the consumable part 5 may be engaged with/inserted into the device part 1. The device 1 has a heating chamber 4 which in use contains the smokable material 5 to be heated and volatised. The smokable material 5 may be in the form of a consumable article, which can be removably inserted into the open end 3 of the device 1 by a user. The article 5 may be a generally elongate cylinder, such as a rod. In use, the article 5 is inserted into the housing 2 such that an end of the article 5 projects out of the device 1 through the open end 3 of the housing 2, and such that a user can place their lips over the article 5 in order to inhale an aerosol generated by the device 1.

The device 1 comprises an electronics/power chamber 6 containing electrical control circuitry 7 and a power source 8. In this example, the heating chamber 4 and the electronics/power chamber 6 are adjacent to each other along the longitudinal axis X-X of the apparatus 1. The electrical control circuitry 7 may include a controller, such as a microprocessor arrangement, configured and arranged to control the heating of the smokable material 5, and incorporates a display driver 15 for controlling images appearing on a display or displays that form part of the device 1, as will be described in more detail below.

The electrical control circuitry 7 may in use receive a signal from, for example, a puff-actuated sensor (not shown) which is sensitive to for example changes in pressure or changes in rate of air flow that occur upon initiation of a draw on the smokable material article 5 by a user. The electrical control circuitry 7 can then operate so as to cause heating of the smokable material article 5 “on demand” when required. Various arrangements for a puff-actuated sensor are available, including for example a thermistor, an electro-mechanical device, a mechanical device, an optical device, an opto-mechanical device and a micro electro mechanical systems (MEMS) based sensor. As an alternative, the device 1 may have a manually operable switch for a user to initiate a puff.

The power source 8 may be a battery, which may be a rechargeable battery or a non-rechargeable battery. Examples of suitable batteries include for example a lithium-ion battery, a nickel battery (such as a nickel-cadmium battery), an alkaline battery and/or the like. The battery 8 is electrically coupled to the one or more heating elements 10 of the heating chamber 4 to supply electrical power when required and under control of the electrical control circuitry 7 to heat and volatize the smokable material 5 without causing it to burn. In this example, the battery 8 is contained within a printed circuit board of the electrical control circuitry 7. In other examples, the battery 8 and the electrical control circuitry 7 may be arranged differently, such as for example arranged adjacent each other along the longitudinal axis X-X of the device 1.

The heating chamber 4 is contained within a heater support sleeve 9, which is contained within the outer housing 2. In this example, the heater support sleeve 9 is a generally elongate cylinder of circular cross-section. In an example, the heater support sleeve 9 is a double-walled or “vacuum” sleeve, having an outer cylindrical wall and an inner cylindrical wall which are joined to each other at each end.

In one example of the device 1, the heater support sleeve 9 contains plural heating elements or heater segments 10. In this example, the heater segments 10 align along or parallel to the longitudinal axis X-X of the heater support sleeve 9. The electrical control circuitry 7 is configured to supply power to the heater segments 10 to heat the smokable material article 5.

The device 1 in accordance with an embodiment of the present invention shown in FIGS. 1 and 2, comprises a display 12 for displaying an image 12a (represented by the letter “A” in FIG. 1), which is visible to a user when the display is in an activated state.

Whilst the display 12 is shown proud of the housing 2 in the FIGS. 1 and 2, it will be understood that the display 12 may be recessed into the housing 2, and can be flush with the outer surface of the housing 2 to give the appearance that it is integrally formed with the housing 2. Integration of the display 12 around the device 1, and recessing the display 12 into the surface of the housing 2, may allow the device 1 to have shape similar to a conventional device and so maintain user familiarity.

As shown in FIG. 1, the display 12 may wrap or extend about the housing 2 and so that it closely conforms to the contours of the housing 2. Ideally, the display 12 will at least give the appearance of forming a part of the housing 2, rather than a separate component, even if the display 12 is applied or wrapped about the housing 2 during manufacture. The display 12 may be flexible to enable it to be manipulated so that it assumes or mimics the contours of the outer surface of the housing 2 during manufacture and assembly.

The display 12 may extend about the longitudinal axis X-X of the housing 2 for any angle. However, the display 12 preferably extends about the housing 2 for at least 90 degrees, at least 180 degrees or 360 degrees, as shown in FIG. 1. The display 12 may also extend in a longitudinal (X-X) direction for the entire, or substantially the entire, length of the housing 2 so that the housing 2 is completely covered, or at least a major portion of the housing 2 is covered, by the display 12. However, there may be areas that are not covered by the display 12, such as a mouthpiece, or an on/off button. In FIGS. 1 and 2, substantially the entire length of the device 1 is covered by the display 12, only short sections 13, 14 of the housing 2 remaining uncovered by the display 12 at opposite ends of the device 1.

In certain circumstances, the display 12 may be resiliently flexible such that a mechanical or pressure sensitive button, i.e. an on/off button, located beneath the display 12 may be activated by applying pressure to the display 12 to temporarily deform the display 12 and, in turn, apply pressure to the button to activate it. Graphics or other images or indicia may appear on the display 12 to indicate to the user the location and/or status of the button located beneath the display 12. The graphics or images may change once the button has been activated. The display 12 may be a flexible display 12 to facilitate formation of the curved viewing surface. In particular, the flexible display 12 may be flexed to provide the curved viewing surface. Once the display 12 is fixed or otherwise coupled to the housing 2, the display 12 may no longer be capable of flexing, for example, when the display 12 is at least partially or entirely attached to the housing 2.

In another embodiment, the display 12 forms an integral part of the housing 2, i.e. the display 12 and the housing 2 are a single integrated component such that the display 12 carries out the dual function of displaying images as well as defining the structural housing containing the components of the device 1, and so the display 12 itself forms the outer surface of the device 1.

The display 12 may be powered by the device battery 8. Alternatively, the display 12 may have its own, separate, power source such as another rechargeable battery (not shown) which is received within the housing 2. The device battery 8 and the display battery may be rechargeable together or independently from each other. The display 12 may be kept ‘on’ by default, only switching off or entering a ‘standby mode’ when, for example, power becomes low, or the device 1 hasn't been used for a period of time, particularly if a display 12 requiring minimum power is used, such as a e-ink type display.

In some embodiments, there can be more than one display 12, located elsewhere on the device 1, i.e. there may be two side-by-side displays 12, or one display may extend partly around the longitudinal axis, with another display extending partly around a remaining part of the axis not covered by the first display. If a second, or further, display is provided, it may have the same or a similar construction to the first display 12. The images 12a displayed on the or each of the first and second displays 12 may be controlled via the display driver 15 of the control circuitry 7 so that there is some association between the displayed images, i.e. a moving image may initiate on one of the displays 12 to complement a different moving image on another display 12, to provide an appealing and interesting overall appearance. Alternatively, one of the displays 12 may be used primarily to provide the user with feedback or information relating to the status of the device 1, whereas another display 12 may be used to show a graphic or an image.

The display 12 may extend or wrap about the longitudinal axis (X-X) for at least 90 degrees, at least 180 degrees, 360 degrees or any other angle, to provide a curved and/or contoured viewing surface. Each of the second displays 12 may extend longitudinally (X-X) for at least part of the length of the housing 2.

The display driver 15 of the control circuitry 7 may be configured to control the display 12 to display predetermined images on the display 12 or on each display 12 if there is more than one.

It will be understood that the images displayed by the or each display 12 may include, comprise or consist of at least one of a solid colour, a pattern, an animation, a graphical representation or any text or other indicia.

In certain embodiments, the control circuitry 7 may be configured to control the displays so that one of the displays 12 displays static images, whilst another displays a moving image. Any suitable static image may be an image displayable on the display 12. The static image may include a cartoon-like image or a realistic image. The static image may be displayed in colour on part of all the display 12.

Any suitable motion image may be an image displayable on the display(s) 12. A motion image may appear as continuous movement or changes in the display 12. For example, brightness or the colour of various pixels may change. The motion image may include a cartoon-like image, a live action image, or a life-like action image (for example, using computer generated graphics).

If more than one display 12 is provided, they can be of the same type. However, each of the displays, or some of the displays 12 may be of a different type. For example, at least one of the displays can be an OLED, flexy TFT, display, OLCD, e-ink (or EPD), an AMOLED (active-matrix organic light-emitting diode display), or a PMOLED display. The type of display 12 will depend on the nature of the images to be displayed. If only single display 12 is employed, it can be any of the above display types.

The display or displays 12 may include a plurality of pixels, for example, arranged into an array that are capable of forming images. The display(s) 12 may be used to show various images at different times. The images may be static images or motions images, which may be a series of static images or an encoded motion image. The display(s) 12 may show one or more viewable elements, selectable elements, and colours. The display 12 may be a colour display.

The control circuit 7 of the aerosol-generating device 1 includes a display driver 15, a communication interface, a controller (for example, a microprocessor or microcontroller), and a memory 17 to store data and images to be displayed by the or each display 12. The control circuitry 7 may be operatively coupled to one or more of the displays 12, to facilitate various functionality of the aerosol-generating device 1.

One or more of the controllers of the control circuitry 7 described herein may include a processor, such as a central processing unit (CPU), computer, logic array, or other device capable of directing data coming into or out of the aerosol-generating device 1. The controller includes one or more computing devices having memory, processing, and communication hardware. The functions of the controller may be performed by hardware and/or as computer instructions on a non-transient computer readable storage medium.

The processor of the controller may include any one or more of a microprocessor, a controller, a microcontroller, a digital signal processor (DSP), an application specific integrated circuit (ASIC), a field-programmable gate array (FPGA), and/or equivalent discrete or integrated logic circuitry. In some examples, the processor may include multiple components, such as any combination of one or more microprocessors, one or more controllers, one or more DSPs, one or more ASICs, and/or one or more FPGAs, as well as other discrete or integrated logic circuitry. The functions attributed to the controller or processor herein may be embodied as software, firmware, hardware, or any combination thereof. While described herein as a processor-based system, an alternative controller could utilize other components such as relays and timers to achieve the desired results, either alone or in combination with a microprocessor-based system.

The exemplary systems, methods, and interfaces may be implemented using one or more computer programs using a computing apparatus, which may include one or more processors and/or memory 17. Program code and/or logic described herein may be applied to input data/information to perform functionality described herein and generate desired output data/information on the or each display 12. It will be readily apparent that the controller functionality as described herein may be implemented in any manner known to one skilled in the art.

The control circuitry 7 may be used to enable various modes of the aerosol-generating device 1. One example includes a visual artistic effect on activation mode, in which a motion image may be shown on the display or displays 12, in response to activation of the device 1, for example, by the actuator or puff senor. Upon detecting a puff and optionally receiving a puff profile, the controller may collect a memory address associated with the visual artistic effect to be shown on the or each of the displays 12. Data associated with the visual artistic effect may be fetched from the memory at the memory address. The data may be used to display or show the visual artistic effect on the or each display 12.

In certain embodiments of the aerosol-generating device 1 of the invention, the control circuitry 7, including the display driver 15, can be configured to display a default image whenever the display 12 is activated. A default image is an image that is always displayed when the display 12 is in an activated state, and which the user cannot change or remove from the display 12, other than by deactivating it.

The control circuitry 7 may also enable at least one user-selected image to be displayed in addition to the default image. A user-selected image is an image that a user can choose to display or not, depending on their preference. A user may opt to have just one, or any number of, user-selectable images displayed on the display 12 together with the default image. The user may select images to be displayed from a menu of user-selectable images, which can be accessible via the display 12, or via a remote device 20. The communication interface may supply a signal to the display driver 15 to display any of the user-selectable images that have been selected by a user. The signal may control the display 12 to swap at least one previously selected user-selectable image for at least one other user-selectable image selected from the menu. Alternatively, the signal may control the display 12 to so that at least one previously selected image is deselected and is no longer displayed together with the default image.

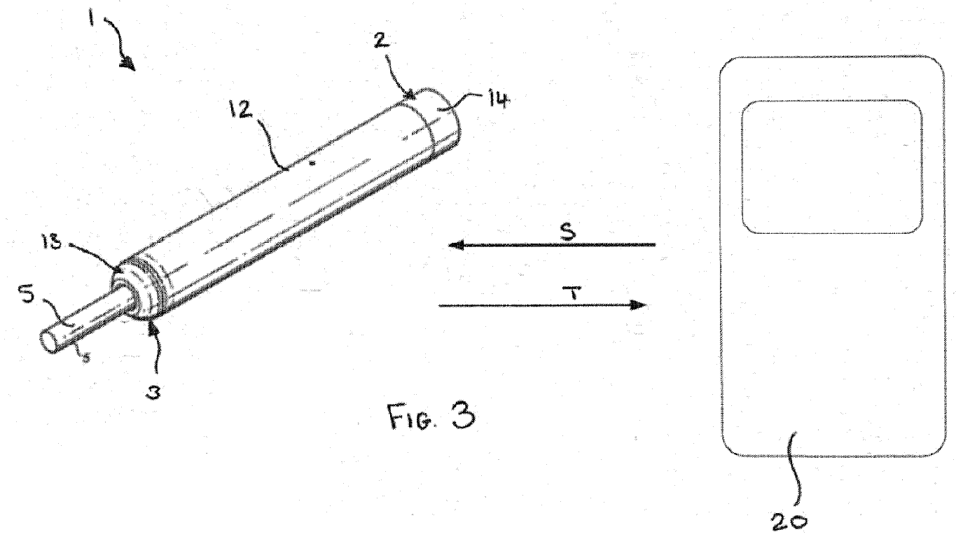

In some embodiments, the communication interface can receive a signal indicative of the at least one user-selected image from a remote device 20 having a user input, such as a smart phone, a tablet, a smart watch or any other wearable technology, and as illustrated in FIG. 3 as a smart phone. A user can select user-selectable images to be displayed from a menu of user-selectable images on said remote device 20, and a signal indicative of the images selected can then be sent, preferably wirelessly, for example, via Bluetooth, from the remote device 20 to the aerosol-generating device 1 to control the display 12 based on the inputs made on the remote device 20.

FIG. 3 illustrates an aerosol-generating device 1, such as the device 1 described above in relation to FIGS. 1 and 2, in communication with a remote device 20. Also illustrated is an article 5, received in the device 1, together forming a system. It will be understood that the remote device 20 communicates with the non-combustible aerosol generating device 1 via signals indicated by letters S and T in FIG. 3, to enable the device 1 to detect the presence of the remote device 20, but also to enable the remote device 20 to be used to control the aerosol-generating device 1, such as to control the display 12.

In any embodiment, the device 1 may comprise a memory for storing image data relating to at least one user-selectable image. Preferably, the memory is capable of storing image data representing multiple images, with other images being stored on a remote device 20 and being downloadable to the device 1 from the remote device 20.

It is also envisaged that the communication interface can be a touchscreen extending entirely or partially over the display 12. Any type of touchscreen, such as a resistive or capacitive touchscreen may be employed. The touchscreen can be an integral part of the display 12 and can be configured to enable a user to select images for display 12 as user-selected images from a menu of user-selectable images displayed on the display 12. The menu of user-selectable images may be displayed in response to controlling the device 1 to enter a user-selection mode. Selection of images for display as user-selected images may then be achieved simply by a user touching regions of the touchscreen displaying the image, or an icon or other information representing the image, or by dragging or moving the image, icon, or other information from one location on the display 12 to another location.

The default and/or user-selected images may be touch-sensitive icons or ‘virtual’ buttons, and the control circuitry 7 may be configured such that an aspect of the aerosol-generating device 1 can be controlled in response to a user touching one or more of the default or user-selected images appearing on the display 12. The default images may therefore be buttons that control critical functions of the device 1 and/or include more important options, such as an on/off switch, whereas the user-selectable images may be buttons that control less-used functions. By selecting the user-selectable images for display as user-selected images together with the default image, the user can make those functions which are personally more important to them more accessible than those functions that they use less often.

In certain embodiments of the non-combustible aerosol provision device 1, the control circuitry 7 is configured to detect the presence of a user and/or a remote device in the proximity of the aerosol-generating device 1. This ability to detect presence may be employed in any of the embodiments described above in relation to the display of a default image, and one or more user-selectable images when the device 1 is in an activated state.

The control circuitry 7 can include a sensor 16 to enable proximity detection. If a user and/or a remote device is detected by the sensor 16, then the display driver 15 may receive a signal from the sensor 16 and switch the display 12 (or at least one of the displays if there are multiple displays) from a deactivated to an activated state, i.e. the detection of a user and/or a remote device acts as a trigger to switch the display 12 from a deactivated state to an activated state so that the display 12 starts displaying one or more default images, and one or more user-selected images of the user-selectable images.

It will be understood that the expression “activated state” is intended to refer to a display 12 which is actively displaying an image, such as a default image and one or more user-selected images. A display 12 which is said to be in an “inactivated state” is one which is not displaying any image, and so can be said to be switched off. A “switched off” display 12 or one which is in a “deactivated state” can also be said to be in what is commonly referred to as “sleep mode” or “standby”, in which the device 1 assumes a low power mode but no images are being displayed.

It will be appreciated that, whilst reference is made to a “user”, this term encompasses persons who intend to use the device 1, but also those in the proximity of the system 1, but who may not actually use the device 1.

If the non-combustible aerosol-generating device 1 is left unattended for a predetermined period of time, as determined by the control circuitry 7, the display 12 can be control so that it switches from an activated to a deactivated state in order to reduce electrical consumption of the battery 8.

The sensor 16 is capable of detecting the presence of a user and/or a remote device proximal to the aerosol-generating device 1, and can supply a signal to the display driver 15 indicative of a detected presence. The display 12 may then be controlled so that it switches to an activated state from a deactivated state so that one or more default images together with one or more user-selected images, are displayed without the device 1, or the display 12, being physically touched.

If the display 12 is switched to its activated state without being touched, the communication interface can be capable of receiving a signal, such as a wireless signal, from a remote device 20, such as the remote device 20 shown in FIG. 3, spaced from, but proximate to, the aerosol-generating device 1 which is indicative of the presence of such a remote device 20. The signal provided by the remote device 20 may be a wireless signal or one that is generated using a Bluetooth® protocol, infrared, near-field communication, or other wireless standard. Alternatively, a type of biometric authentication may be employed, such as a facial recognition system. Such a system has the benefit of switching the display 12 to an activated state only in response to the presence of an authorised user, or switching the display 12 to an activated state so as to display a predetermined or particular image based on an identified user.

In alternative embodiments, the sensor 16 may be a capacitive proximity sensor 16. In any embodiment, the sensor 16 may comprise an array of proximity sensing elements. The array of sensing elements may extend across the surface of the device 1, so that the display 12 will be triggered irrespective of the orientation of the device 1, or the location of the user or remote device 20.

If a touch-sensitive display 12 is employed, the display 12 may switch from a deactivated to an activated state in response to being touched, and the communication interface can be configured to detect the presence of a user, and to send a signal to the display driver 15, in response to the display 12 being touched.

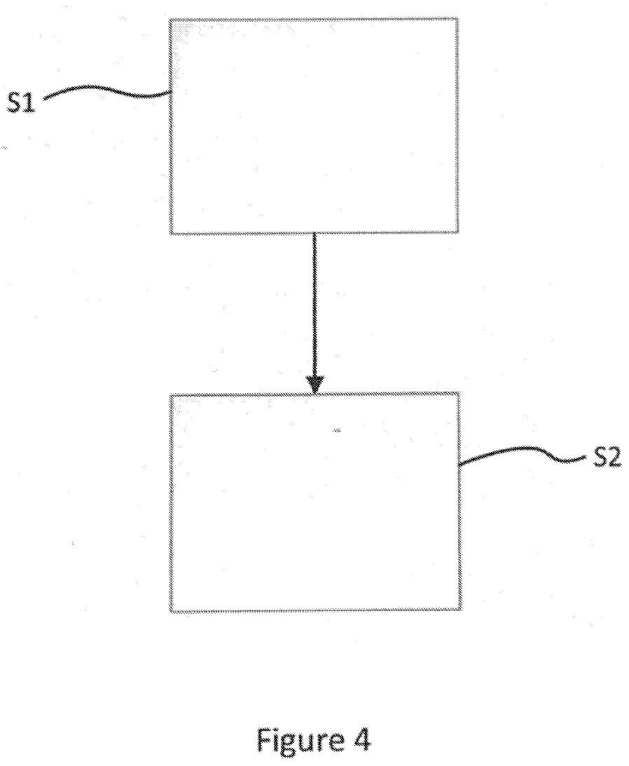

The steps involved in a method of controlling a non-combustible aerosol-generating device 1 according to an above described embodiment of invention, are shown in FIG. 4. In particular, the method can include, at Step S1, configuring the display 12 such that a default image is always displayed when the display 12 is in an activated state. Further, the method can include configuring the control circuitry 7 to enable at least one user-selected image to be displayed in addition to the default image. Selection of user-selected images may be performed via a remote device 20, or directly via the display 12 on the device 1 itself.

In accordance with certain other embodiments, the control circuitry 7 can be configured to detect the presence of a user and/or a remote device 20 spaced from, but proximal to, the aerosol-generating device 1, and to change or modify a displayed image if the presence of a user and/or a remote device 20 proximate to the device 1 is detected. This embodiment may also be employed in conjunction with the embodiment referred to above that relates to the display of default and user-selectable images on the display 12.

In this embodiment, the display driver 15 may be configured to receive a signal from the sensor 16 indicative of the presence of a user and/or a remote device 20, and to change an existing image for another one, or to modify a displayed image by, for example, changing its position, orientation or appearance, which can include its colour or shading, or by combining an image with another image.

If the sensor 16 is capable of detecting a remote device 20, such as a smart phone, a tablet or another non-combustible aerosol-generating device 1, then the sensor 16 can be a communication interface which is configured to receive a signal from a remote device 20 which is located spaced from, but proximate to, the aerosol-generating device 1. As in previous embodiments, the communication interface may be configured to receive a wireless signal, such as a Bluetooth® signal, an infrared signal, or follow the near-field communication protocol, or other wireless standard. A form of biometric authentication, such as a facial recognition system, may also be employed so that images are changed or modified in a different way based on the presence of an identified user.

In an alternate embodiment, the sensor 16 is a capacitive proximity sensor 16, or an array of capacitive proximity sensors 16, or an array of another type of sensor 16, including an audio sensor 16 that detects noise levels in the vicinity of the device 1.

It will be understood that, in accordance with any embodiments of the invention, detection of a user or another device 1 may not only switch the display 12 to an activated state, or change or modify an image being displayed, but may also activate or switch on the device 1, so that the steps required to enable the device 1 to be used are initiated. In addition, or alternatively, detection of a user or another device may unlock the device 1 to enable it to be used.

It should be appreciated that while the above has focused, in part, on an aerosol-generating device of the “heat-not-burn” type, the principles described herein are not limited to aerosol-generating devices of this type. For instance, one or more displays 12 may be provided on an aerosol-generating devices configured to vaporise a liquid source (which may be achieved by vaporising a small amount of liquid extracted from a liquid reservoir containing a bulk liquid using a liquid transport element or wick). Such aerosol-generating devices are typically referred to as a vaping system or electronic nicotine delivery system (END). Such a system is formed of a device part and a cartridge (which is an example of a consumable part).

The cartridge part comprises a housing (e.g., formed of a plastic material), an aerosol-generating material storage area (or liquid reservoir), an aerosol-generating material transfer component (or wicking element, formed for example of a porous ceramic or bundle of fibres, such as cotton) arranged in fluid communication with the aerosol-generating material storage area, an aerosol generator (which may, for example, include a heating element, such as a resistance heating wire wrapped around the wicking element). The aerosol-generating material transfer component is arranged to provide aerosol-generating material (liquid) to the aerosol generator from the aerosol-generating material storage area. An air/aerosol pathway spans from an inlet of the cartridge to an outlet (which may correspond with a mouthpiece part of the cartridge, which in use, is intended to be inserted into the mouth of a user). The air/aerosol pathway passes alongside/in the vicinity of the aerosol generator, such that vapour generated from the aerosol generator may be entrained in air passing through the air/aerosol pathway in order to be delivered to the user. The area surrounding the aerosol-generator thereby forms an aerosol generation area. The device part comprises suitable components to enable and control the aerosol generation, e.g., such as an electronics/power chamber (similar to electronics/power chamber 6) containing electrical control circuitry (similar to electrical control circuitry 7) and a power source (similar to power source 8). Power may be provided from the device part to the consumable to cause the aerosol generator to generate aerosol (e.g., via passing a current through the aerosol generator via electrical contacts provided on the cartridge that engage with electrical contacts on the device part).

In accordance with the present disclosure, one or more displays may be provided on the device part of the aforementioned vaping system (in a substantially similar manner to that as described above with respect to the “heat-not-burn” system). In addition, or alternatively, the or one or more displays may be provided on the cartridge. The cartridge may be configured to receive an electrical input from the device part to control the one or more displays (if present) on the cartridge. Alternatively, the cartridge may be provided with its own power source and/or controller for controlling the one or more displays (if present) on the cartridge.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. A non-combustible aerosol-generating device, comprising:
a display for displaying an image visible to a user in an activated state, and
control circuitry configured so that a default image is always displayed on the display when the display is in an activated state;
wherein the control circuitry is also configured to enable at least one user-selectable image of a plurality of user-selectable images to be displayed in addition to the default image.

2. A non-combustible aerosol-generating device according to claim 1, wherein the control circuitry is configured such that the or each user-selectable image is selectable from a menu of user-selectable images.

3. A non-combustible aerosol-generating device according to claim 1, wherein the control circuitry comprises a display driver configured to display the default image, and the at least one user-selected image of the user-selectable images, when the display is in an activated state.

4. A non-combustible aerosol-generating device according to claim 3, wherein the control circuitry comprises a communication interface, the communication interface being configured to supply a signal to the display driver to display the at least one user-selected image.

5. A non-combustible aerosol-generating system according to claim 4, wherein the communication interface is configured to supply a signal to the display driver to swap at least one user-selected image for at least one other user-selectable image selected from said menu.

6. A non-combustible aerosol-generating device according to claim 4, wherein the communication interface is configured to supply a signal to the display driver to deselect at least one user-selected image, such that the at least one user-selected image which is deselected is/are no longer displayed.

7. A non-combustible aerosol-generating device according to claim 4, wherein said communication interface is configured to receive a signal indicative of the at least one user-selected image from a remote device having a user input configured to enable a user to select user-selectable images to be displayed from said menu of user-selectable images on said remote device.

8. A non-combustible aerosol-generating device according to claim 7, wherein the communication interface is configured to receive a wireless signal from said remote device.

9. (canceled)

10. A non-combustible aerosol-generating device according to claim 3, comprising a memory for storing image data relating to at least one user-selectable image.

11. (canceled)

12. A non-combustible aerosol-generating device according to claim 3, wherein the communication interface is a touchscreen, the touchscreen being configured to enable a user to select images for display as user-selected images from said menu of user-selectable images, in response to a user touching regions of the touchscreen.

13. A non-combustible aerosol-generating device according to claim 12, wherein the control circuitry is configured to enable a user to control the system to enter a user-selection mode in which a menu of user-selectable images is displayed as a list on the display.

14. A non-combustible aerosol-generating device according to claim 13, wherein the control circuitry is configured to enable a user to select images for display as user selected images by touching items in said list.

15. (canceled)

16. A non-combustible aerosol-generating device according to claim 12, wherein the touchscreen is a resistive or capacitive touchscreen.

17. A non-combustible aerosol-generating device according to claim 12, wherein one or more of the default images are touch-sensitive icons, and the control circuitry is configured such that an aspect of the aerosol-generating system is controlled in response to touching one or more of the default images.

18. A non-combustible aerosol-generating device according to claim 12, wherein one or more of the user-selectable images, when selected as user selected images, are touch-sensitive icons, and the control circuitry is configured such that an aspect of the aerosol-generating device is controlled in response to touching one or more of the selected user-selectable images.

19. A non-combustible aerosol-generating device according to claim 3, wherein the control circuitry is configured to detect the presence of a user and/or a remote device in the proximity of the aerosol-generating device, and to switch the display from a deactivated state in which no image is displayed to an activated state in response to said detection such that said default image, and at least one user-selected image of the menu of user-selectable images, are displayed.

20. A non-combustible aerosol-generating device according to claim 19, wherein the control circuitry is configured to control the display so that it switches from an activated to a deactivated state after the control circuitry fails to detect the presence of a user and/or a remote device in the proximity of the aerosol-generating device after a predetermined period of time.

21. A non-combustible aerosol-generating device according to claim 19, wherein the control circuitry comprises a sensor to detect the presence of a user and/or a remote device proximal to the aerosol-generating device, and the display driver is configured to receive a signal from the sensor indicative of said detected presence, and to control the display to switch from a deactivated to an activated state.

22. A non-combustible aerosol-generating device according to claim 21, wherein the sensor is configured to detect the presence of a user and/or a remote device when the user and/or the remote device is spaced from said non-combustible aerosol-generating device, such that the display driver switches the display to an activated state without the aerosol-generating device being touched.

23. (canceled)

24. (canceled)

25. A method of controlling a non-combustible aerosol-generating device, comprising a display for displaying an image visible to a user in an activated state, and
configuring the display such that a default image is always displayed when the display is in an activated state, and
configuring the control circuitry to enable at least one user-selected image to be displayed in addition to the default image, and in which the or each user-selected image is selectable from a menu of user-selectable images.
